(19) United States
(12) Patent Application Publication
(10) Pub. No.: US 2002/0119873 A1
(43) Pub. Date: Aug. 29, 2002

(54) Machine for making filter mouthpieces for rod-shaped smokers' products

(76) Inventor: Uwe Heitmann, Hamburg (DE)

Correspondence Address: VENABLE, BAETJER, HOWARD AND CIVILETTI, LLP, P.O. BOX 34385, WASHINGTON, DC, 20043-9998, US

(21) Appl. No.: 10/057,929

(22) Filed: Jan. 29, 2002

(30) Foreign Application Priority Data
Jan. 29, 2001 (DE) 101 05 012.7

(51) Int. Cl. B31C 13/00

(52) U.S. Cl. 493/39

(57) ABSTRACT

A machine for making composite filter mouthpieces for cigarettes or the like has a conveyor serving to transport a series of upright tubes of paper or the like past a vertically movable plunger which serves to introduce into successive tubes alternating plugs or wads of filter material and batches of flowable granular and/or pulverulent filter material. If the extent to which the plunger descends into a registering tube is outside of a predetermined range, the tube contains an excessive quantity or less than the required quantity of filter material. This is detected by one or more sensors which causes or cause ejection of the respective tube from the path for acceptable filter mouthpieces. A compensating device cooperates with the plunger to allow for proper confinement of flowable filter material against rattling between a pair of filter plugs if the quantity of such flowable filter material in a tube is below an optimum value.

### CROSS-REFERENCE TO RELATED CASES

The present application claims the priority of commonly owned copending German patent application Serial No. 101 05 012.7 filed Jan. 29, 2001. The disclosure of the above-referenced German priority application, as well as that of each US and foreign patent and patent application identified in the specification of the present application, is incorporated herein by reference.

### BACKGROUND OF THE INVENTION

The present invention relates to improvements in machines or apparatus for making filter mouthpieces (hereinafter also called filter plugs) for tobacco smoke. More particularly, the invention relates to improvements in machines for making composite filter mouthpieces which can be utilized with advantage in filter cigarettes, cigars, cigarillos, papirossy and analogous rod-shaped smokers' products. Still more particularly, the invention relates to improvements in machines for manipulating component parts of composite filter mouthpieces in or on their way into filter rod making machines.

Machines of the character to which the present invention pertains are disclosed, for example, in published German patent application No. 17 82 364 which corresponds to British patent No. 1 243 977 and to U.S. Pat. No. 3,603,058 granted Sep. 7, 1971 to Schubert for “METHOD AND APPARATUS FOR THE PRODUCTION OF COMPOSITE FILTER TIPS”. These publications disclose machines for the making of filter mouthpieces which contain at least one supply of flowable (such as granular) filter material for tobacco smoke. Such machines were known as “Bernhard” and were distributed by the assignee of the present application. The so-called multisegment filter mouthpieces which are turned out by the “Bernhard” machine contain at least two different filter materials or filter segments for tobacco smoke. Such materials can include cellulose acetate, paper, tow, granulates, sintered elements, hollow cylinders or chambers, capsules, plugs, wads or the like. In many instances, two or more different filter materials for tobacco smoke are confined in a tubular envelope of paper or the like.

As a rule, or in many instances, the filter rod making machine which turns out filter rod sections or mouthpieces for attachment to plain cigarettes, cigarillos, cigars or other rod-shaped smokers' products is set up to produce filter mouthpieces of twice, four or six times unit length, and such mouthpieces are subdivided into shorter mouthpieces in the filter tipping machine, i.e., in the machine wherein the filter mouthpieces are united with plain cigarettes or the like by socalled tipping paper. For example, the “Bernhard” machine which is disclosed in U.S. Pat. No. 3,603,058 to Schubert turns out filter mouthpieces of twice unit length. This machine employs reciprocable plungers or pushers which serve to introduce plugs or wads of filter material into prefabricated tubular envelopes or into tubes which are obtained by converting strips of paper or other draping material into tubular envelopes for filter material. The plungers are movable along stationary cam faces which cause or permit the plungers to penetrate into or to be withdrawn or expelled from the tubular envelopes.

The aforementioned U.S. patent to Schubert as well as the commonly owned U.S. patent application Ser. No. (Attorney Docket: 31976-177336) (corresponding to German patent applications Nos. 101 05 010.0 and 101 05 011.9) disclose methods of and apparatus for making composite or compound filter plugs for tobacco smoke which can be utilized in conjunction with the method and machine of the present invention.

A drawback of presently known filter mouthpiece making methods and machines is that they are apt to turn out a relatively high percentage of defective filter mouthpieces. This is attributable, at least to a certain extent, to the fact that the instrumentalities which are utilized to introduce metered quantities of filter material (such as granulate) into tubular envelopes of future filter mouthpieces are likely to deliver quantities which vary within a certain range. If a pre-selected optimum quantity of granular filter material is confined between two wads or plugs of filter material, the thus confined granular material cannot generate a rattling noise which is undesirable to the smoker and is indicative of a lower-quality filter mouthpiece because tobacco smoke can readily bypass (and is thus unaffected by) the granulae. Thus, there exists an urgent need for filter rod making machines which can deliver uniform quantities of flowable (such as granular and/or pulverulent) filter material for tobacco smoke and/or which can compensate for the delivery of less than optimal quantities of granular or other flowable filter material for tobacco smoke.

### OBJECTS OF THE INVENTION

An object of the present invention is to provide a novel and improved method of making filter mouthpieces which are not likely to be “noisy” even though they contain one or more supplies or batches of flowable filter material for tobacco smoke in quantities which depart from optimum or intended quantities.

Another object of the invention is to provide a novel and improved method of compensating for departures of supplies of flowable filter material in a series of successive filter mouthpieces from an optimum quantity.

A further object of the invention is to provide a novel and improved method of converting a noise generating semifinished filter mouthpiece into a non-rattling mouthpiece.

An additional object of the invention is to provide a novel and improved non-rattling filter mouthpiece which can be mass produced in filter rod making machines constituting relatively simple and inexpensive modifications of conventional filter rod making machines.

Still another object of the invention is to provide a method and a machine which constitute improvements over and further developments of methods and machines disclosed in the aforediscussed U.S. Pat. No. 3,603,058 to Schubert and in the aforementioned copending U.S. patent application No. (Attorney Docket: 31976-177336).

A further object of this invention is to provide a novel and improved method of and a novel and improved machine for segregating defective or potentially defective filter mouthpieces from satisfactory mouthpieces.

Another object of the invention is to provide novel and improved constituents for use in filter mouthpiece making machines.

An additional object of the invention is to provide a novel and improved filter mouthpiece making machine.

Still another object of the invention is to provide a machine for making and for simultaneously monitoring the condition and/or quality of developing filter mouthpieces for tobacco smoke as well as for comparing the thus ascertained condition with a range of acceptable conditions.

A further object of the invention is to provide a novel and improved distribution of sensors in a filter mouthpiece making machine, i.e., in a machine which supplies filter mouthpieces to a filter tipping machine.

Another object of the invention is to provide a novel and improved combination of parts for use in a machine for the making of filter mouthpieces for rod-shaped smokers' products.

### SUMMARY OF THE INVENTION

One feature of the present invention resides in the provision of a novel and improved combination of parts in a machine which is designed to make filter mouthpieces for attachment to rod-shaped smokers' products in a so-called tipping machine which is designed to turn out filter cigarettes, cigars, cigarillos or the like. The combination comprises a mobile transfer device which is set up to introduce filter material for tobacco smoke (e.g., plugs or wads of sintered filter material, compacted fibrous material or the like) into sections of wrapping material (e.g., into tubes arranged to receive two or more different filter materials) and includes a pusher or plunger which is reciprocable into and from one end of the tube occupying a predetermined portion of a predetermined path for a succession of discrete tubes, guide means for the transfer device (such guide means can include a rail or track which is arranged to maintain the plunger in a predetermined position while in alignment with the tube occupying the predetermined portion of its path), and novel and improved compensating means between the transfer device and the guide means. The compensating means can include one or more elastic components (i.e., it can consist at least in part of a resilient material) which enables or enable the compensating means to cause a longer than normal or longer than anticipated movement of the transfer device when the quantity of filter material in the tube occupying the predetermined portion of its path is less than required, or which enables or enable the compensating means to permit a shorter than normal or anticipated movement of the transfer device when the quantity of filter material in the tube occupying the predetermined portion of the path exceeds the required (such as optimum) quantity.

The guide means can comprise a groove for a portion of the transfer device or for a portion of the compensating means.

The mobile plunger or pusher of the transfer device can be received in a tubular guide member of the compensating means, and such tubular guide member can include a follower received in the groove of the guide means. The combination including such tubular guide member can further comprise means (such as a stop at one end of the plunger) for limiting the extent of movability of the plunger in at least one direction, preferably deeper into the section of wrapping material in the predetermined portion of the path for the sections.

The compensating means can comprise at least one spring, e.g., a helical spring or a spiral.

The means for moving the transfer device (such as the aforementioned plunger) can comprise a motor, e.g., a stepping motor.

The improved combination can further comprise one or more sensors or other suitable means for monitoring the extent of movability of the plunger. For example, the monitoring means can include a power sensor, a contact sensor and/or a distance sensor.

In accordance with one presently preferred embodiment, the compensating means can consist of or include an elastic synthetic plastic material, e.g., a rubber foam which at least partially fills one or more chambers in the transfer device and/or in the guide means.

Another feature of the present invention resides in the provision of a machine for making filter mouthpieces for attachment to smokers' products. The machine comprises a mobile device (e.g., a plunger) for introduction of filter material into at least one section of a wrapping material (e.g., into one of a series of tubes being advanced in upright position along a predetermined path), and a control element which constitutes a means for facilitating only indirect movements of the mobile device. Such apparatus can further comprise a compensating element between the mobile device and the control element.

An additional feature of the present invention resides in the provision of a machine for making filter mouthpieces for smoke which is generated by products of the tobacco processing industry. The machine comprises at least one mobile transfer device (such as a reciprocable plunger) which serves to introduce quantities of tobacco smoke filtering material into tubular receptacles (such as open-ended cylindrical sleeves or tubes of paper or the like), guide means for the transfer device, and means for compensating for departures of quantities of filter material from predetermined or preselected or acceptable quantities.

Still another feature of the instant invention resides in the provision of a machine for making composite filter plugs for attachment to rod-shaped smokers' products. The machine comprises means for advancing a succession of tubular receptacles for filter material for tobacco smoke in a predetermined direction along a predetermined path, adjustable means (such as a plunger) for introducing discrete quantities of filter material into successive receptacles in the path, means for monitoring the quantities of filter material, and means for adjusting the introducing means when the monitored quantities depart from a predetermined value.

The introducing means can be set up for movement relative to successive receptacles in a predetermined portion of the aforementioned path, and the extent of movement of such introducing means is indicative of the quantity of filter material introduced into the receptacle which is then located in the predetermined portion of the path. The monitoring means can include means for ascertaining the extent of movement of the introducing means. This machine can further comprise means for removing from the predetermined path those receptacles wherein the quantity of filter material in the receptacle occupying the predetermined portion of the path causes the introducing means to move through a distance outside of a predetermined range of (acceptable) distances.

The novel features which are considered as characteristic of the invention are set forth in particular in the appended claims. The improved filter mouthpiece making machine itself, however, both as to its construction and the modes of assembling, installing and operating the same, together with numerous additional important and advantageous features and attributes thereof, will be best understood upon perusal of the following detailed description of certain presently preferred specific embodiments with reference to the accompanying drawing.

### BRIEF DESCRIPTION OF THE DRAWING

FIG. 1 is a fragmentary schematic partly developed and partly sectional view of certain parts of a filter mouthpiece making machine including an apparatus which embodies one form of the present invention;

FIG. 2 is a view of a detail of the structure which is shown in FIG. 1;

FIG. 3 illustrates the structure of FIG. 2 but with one of the parts in a different axial position;

FIG. 4 is a view similar to that in the upper part of FIG. 1 but showing certain parts of a different machine; and

FIG. 5 is a view similar to that of FIG. 4 but showing a portion of a third machine.

### DESCRIPTION OF PREFERRED EMBODIMENTS

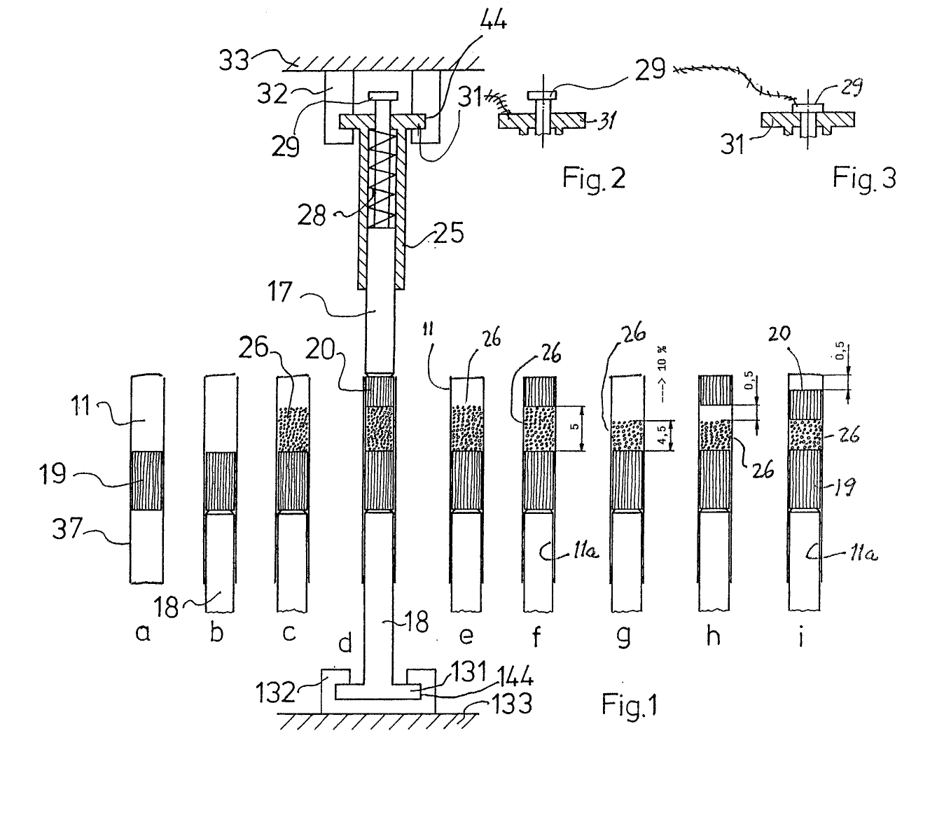

The upper and lower portions of FIG. 1 show certain parts of a filter mouthpiece making machine and the central portion of this Figure illustrates a series of filter mouthpieces during different stages of finish starting at a and ending at i. A filter mouthpiece which undergoes a series of treatments (namely which goes through different stages of filling with filter material for tobacco smoke) includes a section of wrapping material here shown as a cylindrical sleeve or tube 11 made of paper or any other suitable material and being convertible (fillable) into a tubular envelope 37 of the finished filter mouthpiece. A central portion of the sleeve 11 contains a plug or wad 19 of a first filter material which is located in a predetermined axial position of the sleeve by a lower pusher or plunger 18 that enters the sleeve from below at b.

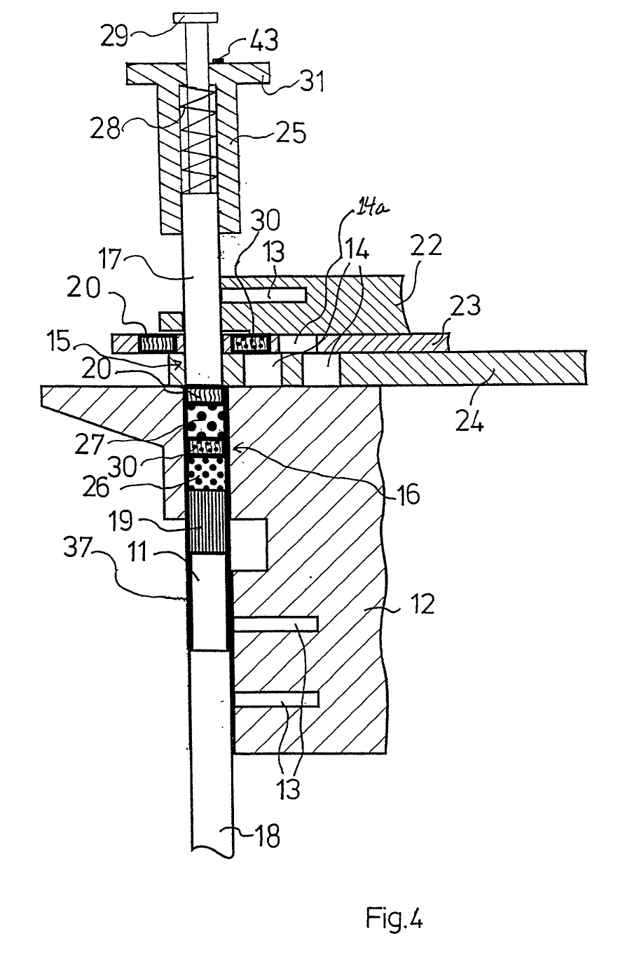

If the plug 19 is bonded to the internal surface of the sleeve 11 in a manner not shown in FIG. 1, the lower plunger 18 serves to hold the sleeve and the plug in a selected axial position, i.e., the axial position of the sleeve 11 is determined by the plunger 18 in that it maintains the plug 19 at a preselected level. The sleeve 11 is assumed to be borne by a suitable conveyor; for example, it can be at least partially confined in a complementary bore or hole or flute 16 of an indexible drum-shaped conveyor 12 (see FIG. 4). The conveyor 12 can operate with suction (see the suction ports 13) to attract the sleeve 11 to the surface surrounding the respective hole or flute 16.

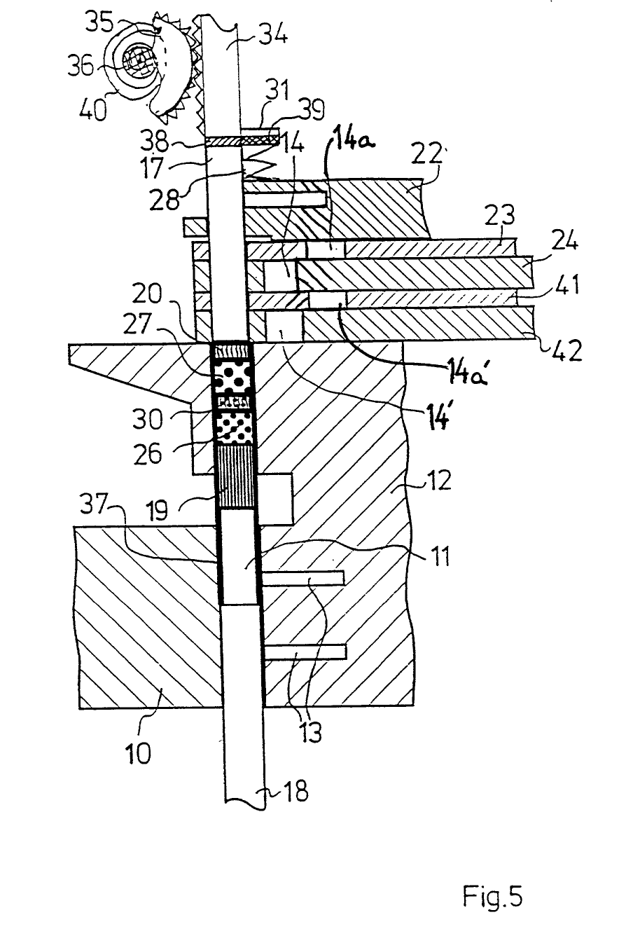

The lower plunger 18 has entered the sleeve 11 at the position b shown in FIG. 1 following the position a which the sleeve assumes immediately upon entry or prior to entry into the hole or flute 16. A renewed indexing of the conveyor 12 including the hole or flute 16 causes the sleeve 11 to assume the position c of FIG. 1 in which the sleeve receives a supply 26 of first granular and/or pulverulent filter material for tobacco smoke. The admission of the supply 26 is assumed to have taken place through one of the bores or holes or passages 14 of a first pusher 24 (see FIG. 4) or through one of the holes or bores or passages 14′ of a second pusher 42 which is shown in FIG. 5. Reference may be had to the aforementioned copending U.S. patent application Serial No. (Attorney Docket: 31976-177336) which was filed jointly with this application.

The next step (see the sleeve 11 in the position d of FIG. 1) involves the introduction (lowering) of an upper pusher or plunger 17 which causes a second plug or wad 20 of filter material for tobacco smoke to enter the sleeve from above toward and into contact with the supply 26 above the plug 19. The sleeve 11 at d in FIG. 1 is assumed to be properly filled, i.e., it confines the plugs 19 and 20 at the desired levels and contains an optimum quantity of flowable filter material 26 between the two plugs.

The upper plunger 17 is reciprocable in a tubular duct or shaft 25 and is biased by at least one resilient element here shown as a coil spring 28 and/or another resilient element which tends to move the plunger 17 downwardly so as to compress or compact the flowable filter matrial 26 to a desired extent if the plugs 19 and 20 are maintained at an optimum distance from each other. The duct 25 has limited freedom of movement.

The plunger 17 extends upwardly into the lower portion of the duct 25 and its upper end portion is provided with a radial extension or collar 31 confined in a fastener 32 borne by the frame 33 of the filter mouthpiece making machine. The fastener 32 has an internal guide groove 44 which receives the collar 31 in such a way that the latter is held at a preselected level. When the sleeve 11 is properly filled with filter materials 19, 20 and 26, the upper plunger 17 is maintained in a predetermined axial position relative to the duct 25, i.e., a stop 29 at the upper end of an elongated axial upward extension of the plunger 17 is spaced apart from the collar 31.

FIG. 2 shows the stop 29 in the same (desired or optimal) axial position relative to the collar 31 as FIG. 1. On the other hand, FIG. 3 shows the stop 29 in a (lower end) position of actual abutment with the collar 31.

FIG. 1 further shows several additional stages of making a composite filter mouthpiece. At e, the sleeve 11 is without the plug 20 and the exact quantity of flowable filter material 26 is yet to be determined. When at f, the flowable filter material 26 has an axial length which equals or approximates 5 mm and which is assumed to be the optimum height. If the axial length of the flowable filter material 26 departs from the optimum axial length by 0.5 mm (see the position g), i.e., by approximately 10%, a conventional filter mouthpiece making machine inserts the plug 20 in such a way that the the axial position of the plug 20 is proper, i.e., the inserted mass of flowable filter material 19 has room to rattle because the allotted space exceeds the required space (for such less than optimal quantity) by 0.5 mm, i.e., by more than 10%. This is undesirable because the finished composite filter mouthpiece is “noisy” as well as because the contact between the particles of flowable filter material 26 and tobacco smoke flowing into the mouth of the smoker is less satisfactory than when tobacco smoke is caused to flow through a filter mouthpiece including the plugs and the flowable filter material shown at f. The filtering action of a flowable filter material which cannot move relative to the sleeve and the adjacent plugs or wads is more satisfactory than that of the flowable filter material which can move relative to the adjacent plugs in response to shaking or analogous movements of the finished filter mouthpiece.

In accordance with a feature of the present invention, the problems encountered by utilizing a “noisy” filter mouthpiece of the type shown at h are overcome by causing the plug 20 to descend to a level directly above the top layer of the shorter-than-desired supply 26 of flowable filter material shown at h. Thus, the wad 20 has been caused to descend to a level which is necessary to eliminate the 0.5 mm gap shown at h. It is assumed that the elimination of such gap necessitates a lowering of the stop 29 to the level of FIG. 3, i.e., to a position of actual abutment with the upper end face of the collar 31. Such lowering of the stop 29 is caused by the coil spring 28 which reacts against the underside of the collar 31 and bears upon the end face at the upper end of the main portion of the upper plunger 17. The axial position of the plunger 17 is determined by the guide groove 44 of the fastener 32 the level of which determines the lower end position of the plunger 17.

In accordance with a further feature of the present invention, a filter mouthpiece wherein the axial length of the column 26 of flowable filter material which is still free to rattle when the stop 29 abuts the collar 31 is less than 4.5 mm is segregated from satisfactory filter mouthpieces. Such segregation is effected by resorting to one or more sensors or monitoring means, e.g., to one or more sensors of the type shown in and about to be described hereinafter with reference to FIGS. 4 and 5.

FIG. 1 further shows that the lower plunger 18 comprises a collar 131 which is received in an elongated guide groove 144 of a fastener 132 borne by a portion 133 of the machine frame. The grooves 44, 144 determine the directions of movement of the plungers 17, 18 relative to the frame of the filter mouthpiece making machine.

The treatment of the sleeve 11 includes a turning through 180° in order to ensure adequate filling of the other side with flowable filter material. This is necessary because the ultimate product is to constitute a triple filter mouthpiece of double unit length or a double filter mouthpiece of three times unit length. When such filter mouthpiece is properly assembled with and is located between two tobacco-containing rod-shaped products (e.g., plain cigarettes, cigarillos or cigars) of unit length, it is severed midway between its ends to yield two filter mouthpieces of unit length each of which forms part of a filter cigarette, cigarillo or cigar of unit length. The manner of making such filter-tipped smokers' products is disclosed, for example, in commonly owned U.S. Pat. No. 5,135,008 granted Aug. 4, 1992 to Oesterling et al.

The manner in which a sleeve can be turned upside down upon completion of the treatment shown at f or i in FIG. 1 is shown in and described with reference to FIG. 14 in each of the commonly owned copending U.S. patent application Ser. No. (Attorney Docket: 31976-177336) to which reference may be had, if necessary. Once the inversion of a sleeve 11 (with a plug 19, supply 26 and plug 20 therein) is completed, the (then) upwardly extending empty portion 11a of the inverted sleeve receives a metered quantity 26 of flowable filter material and a plug 20 in such order. This completes the making of a filter mouthpiece of double unit length which is ready to be severed midway across the plug 19 to yield two filter mouthpieces of unit length each containing one-half of a sleeve 11, one-half of a plug 19, a supply 26 and a plug 20.

FIG. 4 illustrates certain details of a modified machine for the making of composite filter mouthpieces. The structure which is actually shown in FIG. 4 includes several parts which are identical with or plainly analogous to some of those shown in FIG. 1 as well as certain parts having no equivalents in the machine of FIG. 1.

The lower plunger, 18 of the machine shown in FIG. 4 is illustrated in an axial position in which its upper end portion is already received in the bore or hole or flute 16 of the drum-shaped indexible conveyor 12. The latter is provided with the aforementioned suction ports 13 which hold the sleeve 11 in its bore or flute 16 during certain stages of angular movement of the conveyor 12 about its axis. These suction ports serve to transfer the sleeve 11 from a second drum-shaped indexible conveyor 10 which is shown in FIG. 5. The upper plunger 17 extends through one of the bores or holes 14 in the pusher 24 and through a tube 15 which latter extends through registering bores or holes in pushers 23, 24 and a bore or hole in a plate-like conveyor 22 serving to deliver filter plugs 30. The pusher 23 contains filter plugs 20 and 30 in bores 14a for introduction into the second half of the partially filled sleeve 11. Additional flowable filter materials 26 and 27 are delivered into the bores or holes 14 of the pusher 24 at a further admitting station of the filter mouthpiece making machine embodying the structure of FIG. 4.

In the embodiment of FIG. 4, a plug 30 and a metered quantity of flowable filter material 26 are introduced into a sleeve 11 in a first step, and such sleeve receives a second plug 20 and a second metered quantity of flowable filter material 27 in a second step. A sensor 43 (such as a contact sensor) is provided on or at the shoulder 31 of the hollow shaft 25 in the path of downward movement of the stop 29 (or on the stop 29). In the embodiment of FIG. 4, the sensor 43 is stationary relative to the hollow shaft 25.

If the stop 29 of the structure shown in FIG. 4 descends into engagement with the sensor 43, this establishes a path for the flow of electric current for initiation of visual indication by a non-illustrated signal generating device (such as a light source and/or a source of audible signals). When the stop 29 engages the sensor 43, the thus obtained signal or signals is or are indicative of the presence of a defective filter mouthpiece, i.e., of the fact that the quantity of at least one batch of flowable filter material insufficient and/or that the axial length of at least one filter plug or wad is below a normal or optimum or desired axial length. If the filter plugs are satisfactory, the defect consists in that the axial length of at least one batch or supply of flowable filter material in a sleeve 11 is below the desired or acceptable axial length. The signal is utilized to segregate (e.g., pneumatically expel) the corresponding defective filter mouthpiece(s) from the preceding and from the next-following (satisfactory) filter mouthpieces, i.e., the defective filter mouthpiece(s) cannot reach the filter tipping machine, e.g., a machine of the type disclosed in the aforementioned commonly owned U.S. Pat. No. 5,135,008 to Oesterling et al.

FIG. 5 shows certain component parts of a further filter mouthpiece making machine which employs two additional (e.g., plate-like) pushers 41, 42 with bores 14a′ and 14′, respectively, disposed between the pusher 24 and the indexible drum-shaped conveyor 12. Such additional pushers render it possible to make filter mouthpieces of the type containing four different filter materials for tobacco smoke. The upper plunger 17 is not guided in a groove (see the groove 44 in FIG. 1) but is rather guided and moved by an electric motor 36 or another suitable prime mover. The motor 35 transmits torque to a gear 35 by way of a spiral spring 40. The gear 35 mates with a toothed rack 34 which is connected to the upper plunger 17 by way of a piezoelectric element 38. Such connection renders it possible to utilize a force sensor or power sensor, which monitors the torque of the prime mover 36, in addition to or in lieu of the piezoelectric element, i.e., to ascertain the force which is required to move various plugs and/or machine parts. An evaluation of such information renders it possible to draw conclusions concerning the quality of the filter mouthpieces.

The function of the coil spring 28 in the machine of FIG. 5 corresponds to that of the similarly referenced coil spring in the apparatus of FIG. 4. The spring 28 of FIG. 5 bears upon a distance monitoring sensor 39 which is mounted on a shoulder 31 provided on the toothed rack 34 or on the upper plunger 17. For example, the sensor 39 can monitor the distance of the upper side of the conveyor 22 (which delivers filter plugs 20) from the location of such sensor; this is indicative of the extent of movement of the upper plunger 17 in a downward direction (toward the sleeve 11). If a preselected or predetermined minimal distance is exceeded, the signal from the sensor 39 can be utilized to segregate the respective (presumably or actually unsatisfactory) filter mouthpiece(s) from satisfactory mouthpieces. The distance monitoring sensor 39 can constitute or employ an optical sensor, an ultrasonic sensor or a capacitive sensor.

It is possible to modify the machine of FIG. 5 in such a way that the coil spring 28 (or an equivalent thereof) is omitted. Its function can be taken over by the spiral spring 40. If the spring 40 is also omitted, the machine of FIG. 5 can employ an electronic distance monitoring device which can evaluate the distance covered by the upper plunger 17 and/or the magnitude of the force being required to move the plunger. Such force measurement can involve a determination of the torque being transmitted by the prime mover or a determination of the force being monitored by the piezoelectric element 38. In the latter instance, the machine of FIG. 5 employs a suitable signal processing unit and an electronic control unit.

A difference between the embodiments of FIGS. 1 to 4 on the one hand, and the embodiment of FIG. 5 on the other hand, is that the machines of FIGS. 1 and 4 employ a compensating means (25, 28, 40) which operates between the plunger (transfer device) 17 and the guide means 44, 144. On the other hand, the machine embodying the structure of FIG. 5 employs a control element (including the motor 36) which constitutes a means for facilitating only indirect movements of the mobile device (plunger 17) for introduction of filter material into the section (sleeve) 11 of wrapping material.

The parts 25, 28 of the machines shown in FIGS. 1 and 4 or the part 40 of the machine shown in FIG. 5 can be said to constitute a compensating device or compensating means the primary purpose of which is to compensate for differences in the heights of cellulose acetate plugs or wads or segments or elements and correspondingly differently high paper segments and fleece segments as well as different fillers of granulate. For example, if the quantity of flowable filter material is insufficient, the absence of compensating means would result in such introduction of a plug 20 or 30 that the sleeve 11 would contain an empty space (as shown at h in FIG. 1) which could enable the flowable filter material 26 to rattle in the finished filter mouthpiece. The compensating means (25, 28) ensures that the plug 20 descends to the level shown at i in FIG. 1 so that the supply 26 of flowable filter material is held between the plugs 19 and 20 without any, or without any appreciable, freedom of movement and resultant generation of noise.

The guide means or control means can be said to constitute a raising/lowering device (elevator), e.g., a ring-shaped cam which enables the transfer device (plunger 17) to carry out a predetermined movement or a predetermined series of movements.

The solution of problems which exist in conventional filter mouthpiece making machines is particularly simple and advantageous if the compensating means includes an elastic material (such as the coil spring 28 or the spiral spring 40). The elastic material ensures that the guide means (44, 144 or 34, 35, 36) can invariably move along one and the same path. This contributes to simplicity of the guide means. The compensating means renders it possible to introduce the plunger 19 into the tube or sleeve 11 (in the portion d of the path for the sleeve) as far as is necessary to avoid the provision of room for a rattling of one or more batches of flowable (granular and/or pulverulent) filter material. The resiliency of the elastic part or parts of the compensating means is preferably adjustable or variable prior to installation in the machine.

The provision of the sensor 39 or 43 (or another suitable sensor) renders it possible to ascertain the extent of axial displacement of the plunger 17 and hence the extent to which a tube or sleeve 11 (in the portion d of its predetermined path) is filled with filter material for tobacco smoke.

It is also possible to replace the motor 36 of FIG. 5 with an electromagnetic power generator. To this end, at least a portion of the compensating means should consist of a metallic material. This renders it possible to establish a so-called eddy current braking function. At least a portion of the compensating means is or can be magnetizable or magnetized. It is also possible to employ pneumatically operated compensating means. Still further, it is possible to employ a gravity-operated compensating means.

The sensor means which is employed in the improved machine can constitute a power sensor, a contact sensor or a distance sensor. A contact sensor or a distance sensor (the latter can constitute a contact sensor) preferably serves to ascertain the density of filter material in the sleeve 17. This renders it possible to reliably detect and segregate defective filter mouthpieces from satisfactory mouthpieces. For example, the contact sensor (such as 43) can constitute an electric sensor which, when properly engaged, transmits electric current. A distance sensor can operate with light or ultrasonically or can transmit capacitive measurement signals. A power sensor (39) can constitute or employ a piezoelectric element or a torque monitoring device which can ascertain the output of a motor or another prime mover.

The elastic material of the compensating means can constitute a foam which fills at least one space or chamber of the transfer device.

By avoiding a direct coupling of movement of the transfer device with the control element, the extent of movement (i.e., the distance covered by the transfer device or by a part of the transfer device) can be selected independently of the forced movement imparted by the control element (such as 44, 36). It is often preferred to employ a preferably mechanical compensating means which is disposed between the transfer device and the control element. The compensating means of such machine is or can be a spring.

The filter mouthpiece maker which embodies the present invention employs at least one transfer device (such device can include a pusher or plunger) which is operated in accordance with the method of the present invention. In a preferred embodiment of the invention the spring rate or spring constant of the spring 28 can be adjusted. Thus, the force with which the filter material is pushed into the receptacles is also adjustable.

Without further analysis, the foregoing will so fully reveal the gist of the present invention that others can, by applying current knowledge, readily adapt it for various applications without omitting features that, from the standpoint of prior art, fairly constitute essential characteristics of the generic and specific aspects of the above outlined contribution to the art of making filter mouthpieces for cigarettes or the like and, therefore, such adaptations should and are intended to be comprehended within the meaning and range of equivalence of the appended claims.

What is claimed is:

1. In a machine for making filters for attachment to smokers' products, a mobile transfer device for introduction of filter material for tobacco smoke into sections of wrapping material; guide means for said transfer device; and compensating means between said transfer device and said guide means.

2. The structure of claim 1, wherein said guide means comprises a groove for a portion of one of said transfer device and said compensating means.

3. The structure of claim 2, wherein said compensating means includes an elastic material.

4. The structure of claim 2, wherein said transfer device includes at least one mobile plunger.

5. The structure of claim 4, wherein said compensating means includes a tubular guide for said at least one plunger.

6. The structure of claim 4, further comprising means for limiting the extent of movability of said plunger.

7. The structure of claim 1, wherein said compensating means comprises at least one spring.

8. The structure of claim 1, wherein said transfer device comprises at least one mobile plunger and a motor for moving said plunger.

9. The structure of claim 8, wherein said motor is a stepping motor.

10. The structure of claim 1, wherein said transfer device comprises at least one mobile plunger and means for monitoring the extent of movability of said plunger.

11. The structure of claim 10, wherein said monitoring means is selected from the group consisting of power sensors, contact sensors and distance sensors.

12. The structure of claim 1, wherein said compensating means includes elastic synthetic plastic material.

13. The structure of claim 12, wherein said elastic material is a foam.

14. The structure of claim 12, wherein at least one of said transfer device and said guide means has at least one chamber for said elastic material.

15. In a machine for making filters for attachment to smokers' products, the combination of a mobile device for introduction of filter material for tobacco smoke into at least one section of a wrapping material; and a control element constituting a means for facilitating only indirect movements of said device.

16. The combination of claim 15, further comprising a compensating element between said mobile device and said control element.

17. A machine for making filters for smoke generated by products of the tobacco processing industry, comprising at least one mobile transfer device for the introduction of quantities of tobacco smoke filtering material into tubular receptacles; guide means for said transfer device; and means for compensating for departures of quantities of filter material from predetermined quantities.

18. In a machine for making composite filter plugs for attachment to rod-shaped smokers' products, the combination of:
means for advancing a succession of tubular receptacles for filter material for tobacco smoke in a predetermined direction along a predetermined path;
adjustable means for introducing discrete quantities of filter material into successive receptacles in said path;
means for monitoring said quantities of filter material; and
means for adjusting said introducing means when the monitored quantities depart from a predetermined value.

19. The combination of claim 18, wherein said introducing means is movable relative to successive receptacles in a predetermined portion of said path and the extent of movement of said introducing means is indicative of the quantity of filter material introduced into the receptacle then located in said portion of said path, said monitoring means including means for ascertaining the extent of movement of said introducing means.

20. The combination of claim 18, further comprising means for removing from said path those receptacles wherein the quantity of filter material in the receptacle occupying said portion of said path causes the introducing means to move through a distance outside of a predetermined range of distances.
